(19) United States
(12) Patent Application Publication
(10) Pub. No.: US 2026/0133049 A1
(43) Pub. Date: May 14, 2026

(54) COLLABORATIVE PERCEPTION SYSTEM FOR CREATING A BIRD’S EYE VIEW COOPERATIVE PERCEPTION MAP

(71) Applicants: GM Global Technology Operations LLC, Detroit, MI (US); Regents of the University of Michigan, Ann Arbor, MI (US)

(72) Inventors: Ruiyang Zhu, Ann Arbor, MI (US); Shuqing Zeng, Sterling Heights, MI (US); Fan Bai, Ann Arbor, MI (US); Zhuoqing Morley Mao, Ann Arbor, MI (US)

(21) Appl. No.: 18/946,493

(22) Filed: Nov. 13, 2024

(51) Int. Cl. G01C 21/00; G06N 3/0455; H04W 4/44

(52) U.S. Cl. CPC G01C 21/3841; G01C 21/387; G06N 3/0455; H04W 4/44

(57) ABSTRACT

A collaborative perception system for creating a bird’s eye view cooperative perception map based on bird’s eye view perception data collected by a plurality of vehicles includes one or more central computers in wireless communication with one or more controllers of each of the plurality of vehicles located in an environment. The one or more central computers executing instructions to perform lost feature reconstruction to create a plurality of corresponding repaired feature maps for each of the plurality of vehicles, an initial cross attention map, and a temporal attention map. The one or more central computers fuse the temporal attention map and the initial cross attention map together to create a fused bird’s eye view attention map and create the bird’s eye view cooperative perception map based on the fused bird’s eye view attention map.

### INTRODUCTION

The present disclosure relates to a collaborative perception system for creating a bird’s eye view cooperative perception map that is based on bird’s eye view perception data collected by a plurality of vehicles.

An autonomous vehicle executes various tasks such as, but not limited to, perception, localization, mapping, path planning, decision making, and motion control. As an example, an autonomous vehicle may include perception sensors for collecting perception data regarding the environment surrounding the vehicle. However, sometimes objects located in the surrounding environment may not be seen or detected by the perception sensors corresponding to an autonomous vehicle for a variety of reasons.

One approach to alleviate the above-mentioned issues regarding the perception sensors involves partial sharing of perception data between multiple vehicles under a wireless network to create a map. However, there are several challenges that may be faced when attempting to fuse the perception data together to create a map. Specifically, the perception data shared between vehicles may have non-negligible amounts of misalignment due to localization and synchronization errors. Furthermore, there may be a loss of perception data due to a variety of reasons such as, but not limited to, unreliable or lossy networks, channel noise, packet transmission collision, jamming by malicious hackers, and ambient interference, which may further exacerbate the issues faced when attempting to fuse the perception data together. As an example, the lossy communication experienced by a vehicle-to-vehicle (V2V) network sometimes results in network packet loss.

Thus, while current perception systems achieve their intended purpose, there is a need in the art for an improved approach for sharing perception data between vehicles.

### SUMMARY

According to several aspects, a collaborative perception system for creating a bird’s eye view cooperative perception map based on bird’s eye view perception data collected by a plurality of vehicles is disclosed. The collaborative perception system includes one or more central computers in wireless communication with one or more controllers of each of the plurality of vehicles located in an environment. The one or more central computers executes instructions to receive an individual bird’s eye view feature map from each of the plurality of vehicles and perform lost feature reconstruction to reconstruct one or more lost feature indices within the individual bird’s eye view feature map for each of the plurality of vehicles to create a plurality of corresponding repaired feature maps for each of the plurality of vehicles. The one or more central computers address spatial misalignments within a first individual bird’s eye view feature map from an ego vehicle based on the plurality of corresponding repaired feature maps for each the plurality of vehicles to create an initial cross attention map, wherein the first individual bird’s eye view feature map from the ego vehicle is based on a current timestep. The one or more central computers calculate a temporal attention map by transforming a second individual bird’s eye view feature map that is based on a previous timestep from the ego vehicle from the previous timestep to a current timestamp based on a difference between a first ego vehicle pose and a second ego vehicle pose to create a temporally aligned bird’s eye view feature map, and then performing deformable attention upon the temporally aligned bird’s eye view feature map and the first individual bird’s eye view feature map. The one or more central computers fuse the temporal attention map and the initial cross attention map together to create a fused bird’s eye view attention map and create the bird’s eye view cooperative perception map based on the fused bird’s eye view attention map.

In another aspect, the one or more central computers include a masked autoencoder network having an encoder and a decoder.

In yet another aspect, the one or more central computers execute instructions to: patchify each of the individual bird’s eye view feature maps into a plurality of patches, wherein each patch is sized to include one or more feature vectors of the individual bird’s eye view feature map.

In an aspect, the one or more central computers execute instructions to: learn, by the encoder of the masked autoencoder network, characteristics of non-corrupted patches that are part of the individual bird’s eye view feature map that omit the one or more lost feature indices, and recover, by the decoder of the masked autoencoder network, remaining patches of the individual bird’s eye view feature map that include the one or more lost feature indices based on the characteristics of the non-corrupted patches learned by the encoder to create the corresponding repaired feature map for each of the plurality of vehicles.

In another aspect, the size of each patch is based on a level of detail required by the collaborative perception system and an amount computational power available by the one or more central computers.

In yet another aspect, the one or more central computers determine the initial cross attention map by: comparing each feature vector located within the first individual bird’s eye view feature map with a predefined number of equivalent individual feature vectors located within each of the plurality of corresponding repaired feature maps for each of the plurality of vehicles to determine an attention weight, and calculating a unique cross attention map corresponding to each of the predefined number of equivalent individual feature vectors, wherein each individual feature vector of each unique cross attention map represents a unique attention weight.

In an aspect, the attention weight represents a similarity between a particular feature vector located within the first individual bird’s eye view feature map and an equivalent individual feature vector located a corresponding repaired feature map.

In another aspect, the one or more central computers determine the initial cross attention map by: comparing the attention weights corresponding to each feature vector across each of the unique cross attention maps corresponding to each specific position within the unique cross attention maps to determine a maximum attention weight, and assigning the attention weight of the feature vector having the maximum attention weight to the feature vector within the initial cross attention map having the same specific position.

In yet another aspect, the one or more controllers of the plurality of vehicles are in wireless communication with one another based on a vehicle-to-everything (V2X) communication network.

In an aspect, the one or more central computers fuse the temporal attention map and the initial cross attention map together to create the fused bird’s eye view attention map by: comparing attention weights corresponding to each feature vector within the initial cross attention map with a corresponding feature vector located in the same specific position within the temporal attention map to determine a maximum attention weight, and assigning the attention weight of the feature vector having the maximum attention weight to the feature vector within the fused bird’s eye view attention map having the same specific position.

In another aspect, a collaborative perception system for creating a bird’s eye view cooperative perception map based on bird’s eye view perception data collected by a plurality of vehicle is disclosed. The collaborative perception system includes an ego vehicle including one or more controllers in wireless communication with each of the plurality of vehicles located in an environment. The one or more controllers of the ego vehicle execute instructions to receive an individual bird’s eye view feature map from each of the plurality of vehicles and perform lost feature reconstruction to reconstruct one or more lost feature indices within the individual bird’s eye view feature map for each of the plurality of vehicles to create a plurality of corresponding repaired feature maps for each of the plurality of vehicles. The one or more controllers address spatial misalignments within a first individual bird’s eye view feature map from an ego vehicle based on the plurality of corresponding repaired feature maps for each the plurality of vehicles to create an initial cross attention map, where the first individual bird’s eye view feature map from the ego vehicle is based on a current timestep. Creating the initial cross attention map includes: comparing each feature vector located within the first individual bird’s eye view feature map with a predefined number of equivalent individual feature vectors located within each of the plurality of corresponding repaired feature maps for each of the plurality of vehicles to determine an attention weight, and calculating a unique cross attention map corresponding to each of the predefined number of equivalent individual feature vectors, wherein each individual feature vector of each unique cross attention map represents a unique attention weight. The one or more controllers calculate a temporal attention map by transforming a second individual bird’s eye view feature map that is based on a previous timestep from the ego vehicle from the previous timestep to a current timestamp based on a difference between a first ego vehicle pose and a second ego vehicle pose to create a temporally aligned bird’s eye view feature map, and then performing deformable attention upon the temporally aligned bird’s eye view feature map and the first individual bird’s eye view feature map. The one or more controllers fuse the temporal attention map and the initial cross attention map together to create a fused bird’s eye view attention map and create the bird’s eye view cooperative perception map based on the fused bird’s eye view attention map.

In another aspect, the one or more controllers of the ego vehicle include a masked autoencoder network having an encoder and a decoder.

In yet another aspect, the one or more controllers of the ego vehicle execute instructions to: patchify each of the individual bird’s eye view feature maps into a plurality of patches, wherein each patch is sized to include one or more feature vectors of the individual bird’s eye view feature map.

In an aspect, the one or more controllers of the ego vehicle execute instructions to: learn, by the encoder of the masked autoencoder network, characteristics of non-corrupted patches that are part of the individual bird’s eye view feature map that omit the one or more lost feature indices, and recover, by the decoder of the masked autoencoder network, remaining patches of the individual bird’s eye view feature map that include the one or more lost feature indices based on the characteristics of the non-corrupted patches learned by the encoder to create the corresponding repaired feature map for each of the plurality of vehicles.

In another aspect, the size of each patch is based on a level of detail required by the collaborative perception system and an amount computational power available by the one or more controllers of the ego vehicle.

In yet another aspect, the one or more controllers of the ego vehicle determine the initial cross attention map by: comparing each feature vector located within the first individual bird’s eye view feature map with a predefined number of equivalent individual feature vectors located within each of the plurality of corresponding repaired feature maps for each of the plurality of vehicles to determine an attention weight, and calculating a unique cross attention map corresponding to each of the predefined number of equivalent individual feature vectors, wherein each individual feature vector of each unique cross attention map represents a unique attention weight.

In an aspect, the attention weight represents a similarity between a particular feature vector located within the first individual bird’s eye view feature map and an equivalent individual feature vector located a corresponding repaired feature map.

In another aspect, the one or more controllers of the ego vehicle determine the initial cross attention map by: comparing the attention weights corresponding to each feature vector across each of the unique cross attention maps corresponding to each specific position within the unique cross attention maps to determine a maximum attention weight, and assigning the attention weight of the feature vector having the maximum attention weight to the feature vector within the initial cross attention map having the same specific position.

In yet another aspect, the plurality of vehicles are in wireless communication with one another based on a vehicle-to-everything (V2X) communication network.

In an aspect, a collaborative perception system for creating a bird’s eye view cooperative perception map based on bird’s eye view perception data collected by a plurality of vehicles is disclosed. The collaborative perception system includes one or more central computers in wireless communication with one or more controllers of each of the plurality of vehicles located in an environment. The one or more central computers executes instructions to receive an individual bird’s eye view feature map from each of the plurality of vehicles and perform lost feature reconstruction to reconstruct one or more lost feature indices within the individual bird’s eye view feature map for each of the plurality of vehicles to create a plurality of corresponding repaired feature maps for each of the plurality of vehicles. The one or more central computers address spatial misalignments within a first individual bird’s eye view feature map from an ego vehicle based on the plurality of corresponding repaired feature maps for each the plurality of vehicles to create an initial cross attention map, where the first individual bird’s eye view feature map from the ego vehicle is based on a current timestep. The one or more central computers calculate a temporal attention map by transforming a second individual bird’s eye view feature map that is based on a previous timestep from the ego vehicle from the previous timestep to a current timestamp based on a difference between a first ego vehicle pose and a second ego vehicle pose to create a temporally aligned bird’s eye view feature map, and then performing deformable attention upon the temporally aligned bird’s eye view feature map and the first individual bird’s eye view feature map. The one or more central computers fuse the temporal attention map and the initial cross attention map together to create a fused bird’s eye view attention map and create the bird’s eye view cooperative perception map based on the fused bird’s eye view attention map.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates a schematic diagram of the disclosed collaborative perception system including one or more central computers in wireless communication with a plurality of vehicles, according to an exemplary embodiment;

FIG. 2 is an illustration of an ego vehicle that is part of the plurality of vehicles shown in FIG. 1, according to an exemplary embodiment;

FIG. 3 illustrates the software architecture of the one or more central computers shown in FIG. 1, according to an exemplary embodiment;

FIG. 4 illustrates a masked autoencoder network that is part of the one or more central computers, according to an exemplary embodiment;

FIG. 5 illustrates two different approaches to patchify an individual bird’s eye view feature map into a plurality of patches, according to an exemplary embodiment;

FIG. 6 is a block diagram of a deformable spatial cross attention (DSCA) submodule that is part of the one or more central computers, according to an exemplary embodiment; and

FIG. 7 is a block diagram of a spatial-temporal fusion module that is part of the one or more central computers, according to an exemplary embodiment.

### DETAILED DESCRIPTION

The following description is merely exemplary in nature and is not intended to limit the present disclosure, application, or uses.

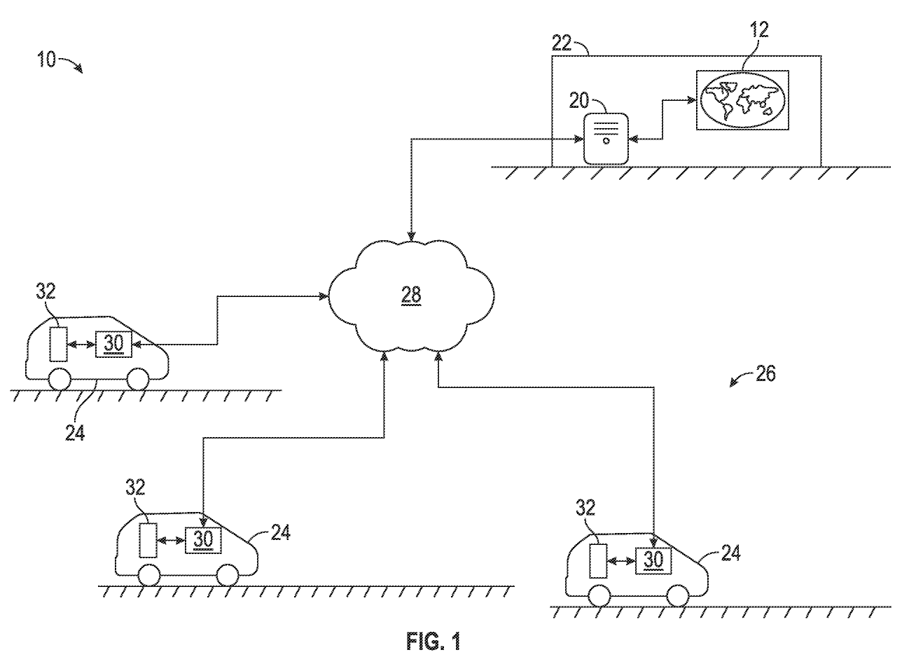

Referring to FIG. 1, an exemplary collaborative perception system 10 for creating a bird’s eye view cooperative perception map 12 is illustrated. The collaborative perception system 10 includes one or more central computers 20 located at a back-end office 22 in wireless communication with one or more controllers 30 of a plurality of vehicles 24. The one or more central computers 20 are in wireless communication with the plurality of vehicles 24 located in an environment 26 via a communication network 28. It is to be appreciated that the plurality of vehicles 24 may each be any type of vehicle such as, but not limited to, a sedan, a truck, sport utility vehicle, van, or motor home. In one embodiment, the communication network 28 is based on a lossy wireless networking protocol such as, but not limited to, a vehicle-to-everything (V2X) communication network.

In the non-limiting embodiment as shown in FIG. 1, each vehicle 24 includes the one or more controllers 30 in electronic communication with a plurality of perception sensors 32 that collect bird’s eye view perception data regarding the environment 26. The communication network 28 wirelessly connects each of the one or more controllers 30 of each vehicle 24 with the one or more central computers 20 and the one or more controllers 30 corresponding to one or more remaining vehicles 24. The perception sensors 32 corresponding to each vehicle 24 collect the bird’s eye view perception data representing the environment 26. As explained below, the one or more central computers 20 create the bird’s eye view cooperative perception map 12 by crowdsourcing the bird’s eye view perception data collected by the plurality of vehicles 24. The plurality of vehicles 24 are each located within a predefined distance of one another so as to capture similar bird’s eye view perception data. In one exemplary embodiment, the predefined distance may range from about fifty to about seventy-five meters.

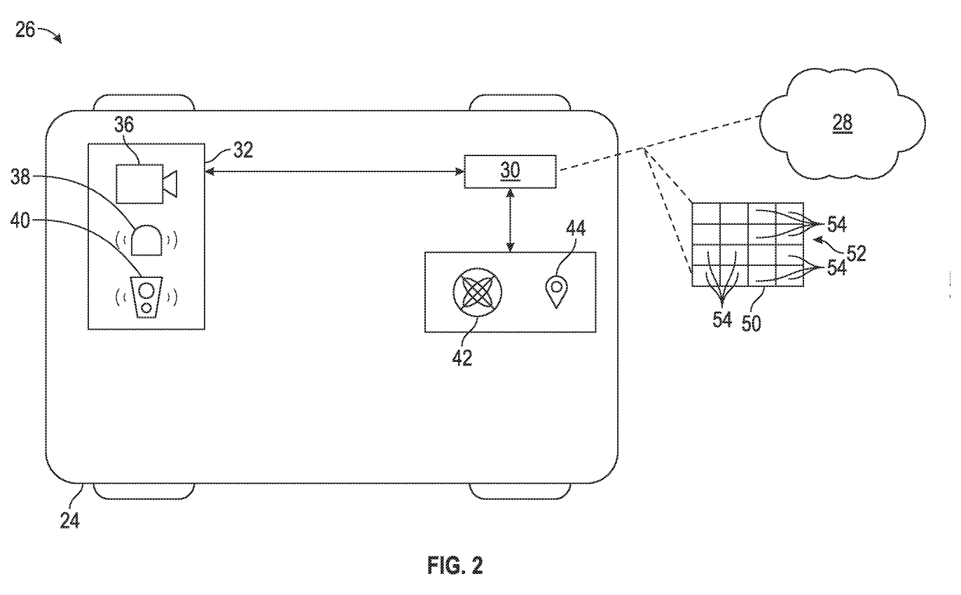

FIG. 2 is an illustration of one of the plurality of vehicles 24 traveling in the environment 26, where the vehicle 24 shown in FIG. 2 may be referred to as the ego vehicle. In the non-limiting embodiment as shown in FIG. 2, the plurality of perception sensors 32 include one or more cameras 36 for collecting bird’s eye view image data, radar 38, and LiDAR 40, however, it is to be appreciated that any perception sensor that captures bird’s eye view perception data regarding the surrounding environment 26 may be used as well. It is also to be appreciated that the one or more cameras 36 may include monocular cameras as well as stereo cameras. The plurality of perception sensors 32 collect the bird’s eye view perception data representative of the environment 26. The ego vehicle 24 also includes an inertial measurement unit (IMU) 42 and a global positioning system (GPS) 44 in electronic communication with the one or more controllers 30.

Referring to FIGS. 1 and 2, the one or more controllers 30 of each vehicle 24 combine the bird’s eye view perception data collected by the plurality of perception sensors 32 with map data representative of the environment 26 to create an individual bird’s eye view feature map 50. In one embodiment, the map data may be high-definition map data, however, it is to be appreciated that other types of map data may be used as well. The individual bird’s eye view feature map 50 includes a grid configuration 52 that divides the individual bird’s eye view feature map 50 into a plurality of equally sized feature vectors 54. Each feature vector 54 signifies a real-world measurement of the bird’s eye view perception data corresponding to a predefined area of the environment 26.

Merely by way of example, in one embodiment each feature vector 54 of the individual bird’s eye view feature map 50 represents a 0.5 x 0.5 meter area of the environment 26. In one non-limiting embodiment, the individual bird’s eye view feature map 50 is divided into a 4 x 4 grid configuration 52 having a height of four feature vectors 54, a width of four feature vectors 54, and a channel size of two hundred and fifty-six feature vectors 54 to create a matrix having the dimensions (4, 4, 256).

Continuing to refer to FIGS. 1 and 2, each of the controllers 30 of the plurality of vehicles 24 may transmit the respective individual bird’s eye view feature map 50 over the communication network 28 to the one or more central computers 20. The one or more central computers 20 receive an individual bird’s eye view feature map 50 from each of the plurality of vehicles 24 over the communication network 28. Alternatively, in another implementation, each of the controllers 30 of the plurality of vehicles 24 may transmit the respective individual bird’s eye view feature map 50 over the communication network 28 to the ego vehicle 24 instead.

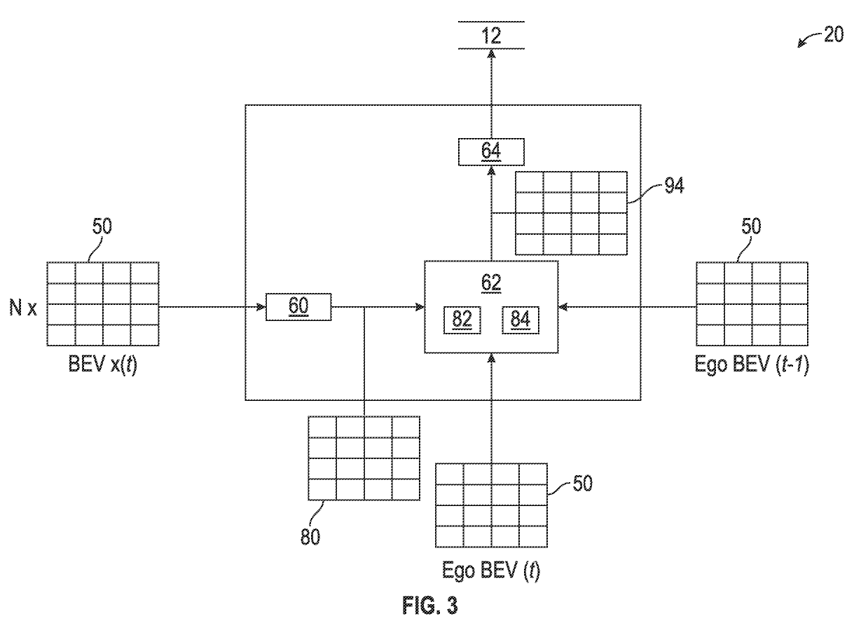

FIG. 3 illustrates the software architecture of the one or more central computers 20. It is to be appreciated that although FIG. 3 illustrates the software architecture implemented by the one or more central computers 20, in another embodiment the software architecture may be implemented by the one or more controllers 30 of the ego vehicle 24. As seen in FIG. 3, the one or more central computers 20 include a lost bird’s eye view feature reconstruction (L-BEV-R) module 60 to reconstruct corrupted bird’s eye view feature map caused by lossy communication channels, a spatial-temporal fusion module 62, and a post-processing block 64.

The L-BEV-R module 60 of the one or more central computers 20 shall now be described. Referring to both FIGS. 1 and 3, the L-BEV-R module 60 of the one or more central computers 20 receives a number N of individual bird’s eye view feature maps 50 from each of the plurality of vehicles 24 over the communication network 28 at a current timestep x(t). The number N represents the number of vehicles 24 that are considered by the L-BEV-R module 60 (excluding the ego vehicle 24), where the number N may be any value greater than two.

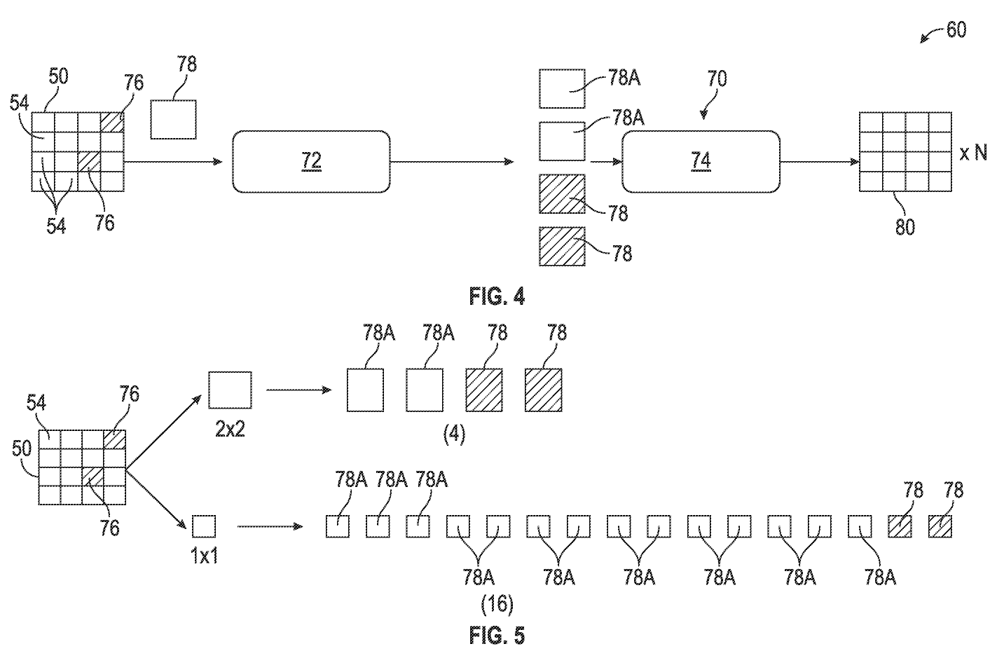

As explained below, the L-BEV-R module 60 includes a masked autoencoder network 70 (FIG. 4) that performs lost feature reconstruction to reconstruct one or more lost feature indices 76 within the individual bird’s eye view feature maps 50 for each of the plurality of vehicles 24 based on one or more unsupervised learning techniques to create a plurality of corresponding repaired feature maps 80 for each of the plurality of vehicles 24. The lost feature indices 76 represent feature vectors 54 within the individual bird’s eye view feature map 50 that indicate areas within the environment 26 where the bird’s eye view perception data has been lost. The bird’s eye view perception data may be lost because of a variety of different reasons such as, for example, unreliable or lossy networks (such as a V2X network), channel noise, packet transmission collision, jamming by malicious hackers, and ambient interference.

FIG. 4 is a block diagram of the L-BEV-R module 60. Referring to both FIGS. 3 and 4, the L-BEV-R module 60 includes the masked autoencoder network 70 having an encoder 72 and a decoder 74. The L-BEV-R module 60 may first patchify each of the individual bird’s eye view feature maps 50 into a plurality of patches 78, where each patch 78 is sized to include one or more feature vectors 54 of the individual bird’s eye view feature map 50. Referring to FIG. 5, in one non-limiting embodiment, the individual bird’s eye view feature map 50 has a height of four feature vectors 54, a width of four feature vectors 54, and a channel size of two hundred and fifty-six feature vectors 54 (i.e., a matrix of size (4, 4, 256)). In one embodiment, the size of each patch 78 is 2 x 2, so each patch 78 includes four feature vectors 54 and each patch 78 includes a matrix size of (2, 2, 256), thereby resulting in four patches 78 in total. In another embodiment, the size of each patch 78 is 1 x 1, so each patch 78 includes one feature vector 54 and each patch 78 includes a matrix size of (1, 1, 256), thereby resulting in sixteen patches 78 in total.

It is to be appreciated that a smaller sized patch 78 results in a more fine-grained analysis of the individual bird’s eye view feature map 50 while a larger sized patch 78 requires fewer computational resources. Thus, the size of each patch 78 is based on a level of detail required by the collaborative perception system 10 and the amount computational power available by the one or more central computers 20 (or the one or more controllers 30, if applicable).

Referring back to FIG. 3, the encoder 72 of the masked autoencoder network 70 learns characteristics of non-corrupted patches 78A that are part of the individual bird’s eye view feature map 50 that omit or do not include a lost feature indices 76. In the example as shown in FIG. 3, the individual bird’s eye view feature map 50 includes two non-corrupted patches 78A that do not include a lost feature indices 76, while the remaining two patches 78 include a lost feature indices 76. The decoder 74 of the masked autoencoder network 70 may then recover the remaining patches 78 of the individual bird’s eye view feature map 50 that include the lost feature indices 76 based on the characteristics of the non-corrupted patches 78A learned by the encoder 72 to create the corresponding repaired feature map 80 for each vehicle 24. The L-BEV-R module 60 of the one or more central computers 20 may then transmit the plurality of corresponding repaired feature maps 80 for each vehicle 24 of the plurality of vehicles 24 to the spatial-temporal fusion module 62.

The spatial-temporal fusion module 62 of the one or more central computers 20 shall now be described. Referring to FIG. 3, the spatial-temporal fusion module 62 includes a deformable spatial cross attention (DSCA) submodule 82 and a historical temporal alignment submodule 84. The spatial-temporal fusion module 62 of the one or more computers 20 receives a first individual bird’s eye view feature map 50 from the ego vehicle 24 (FIG. 2) over the communication network 28 at the current timestep (t) as well as a second individual bird’s eye view feature map 50 from the ego vehicle 24 at a previous timestep (t – 1).

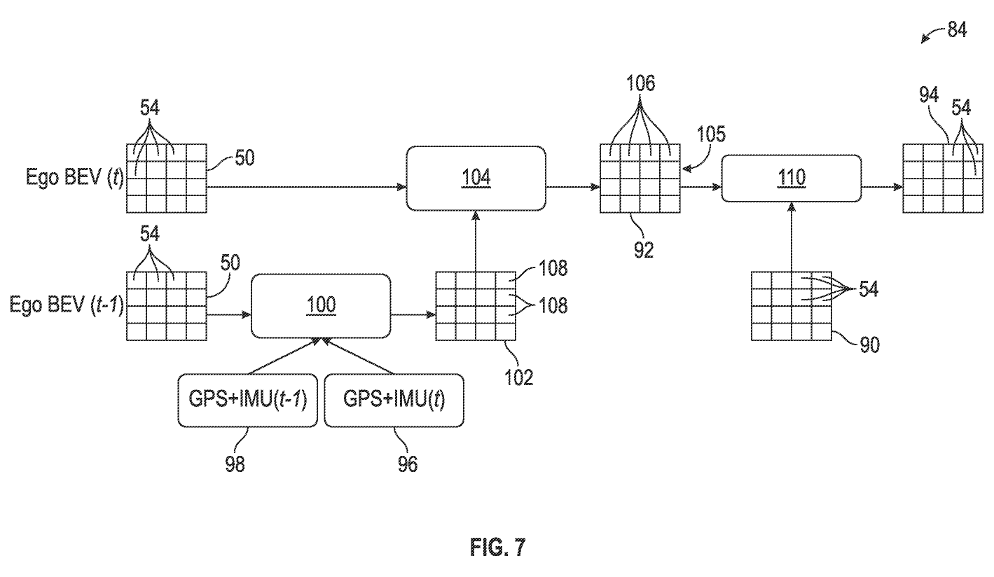

The DSCA submodule 82 of the spatial-temporal fusion module 62 addresses spatial misalignments within the first individual bird’s eye view feature map 50 at the current timestep (t) from the ego vehicle 24 (FIG. 2) based on the plurality of corresponding repaired feature maps 80 for each vehicle 24 as determined by the L-BEV-R module 60 to create an initial cross attention map 90 (FIG. 5). As explained below, the initial cross attention map 90 is fused together with a temporal attention map 92 (FIG. 7) to create a fused bird’s eye view attention map 94 that is transmitted to the post-processing block 64 (FIG. 2). The post-processing block 64 determines the bird’s eye view cooperative perception map 12 based on the fused bird’s eye view attention map 94.

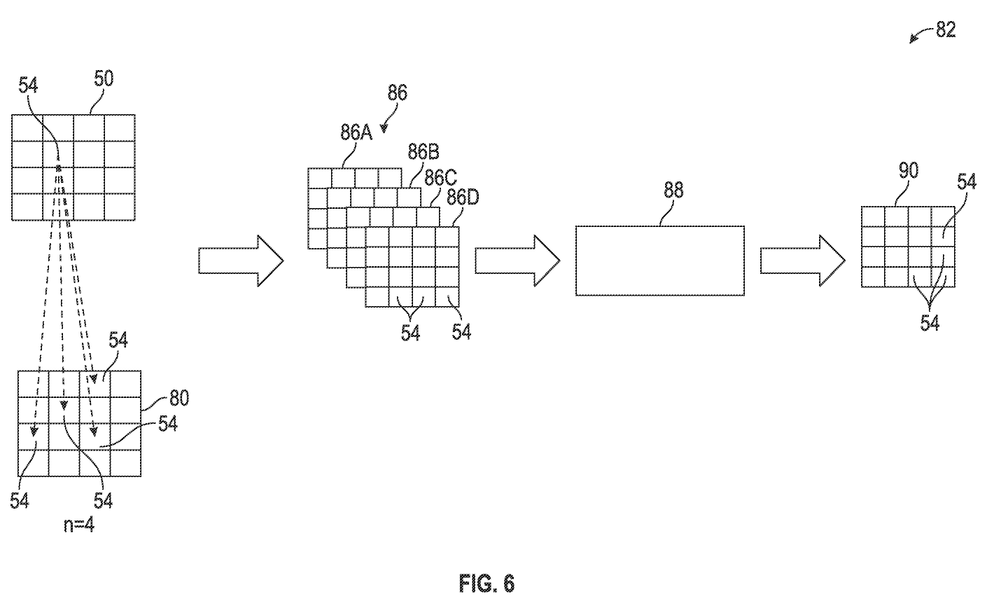

FIG. 6 is a block diagram of the DSCA submodule 82 shown in FIG. 3. Referring to FIGS. 3 and 6, the DSCA submodule 82 addresses the spatial misalignments within the first individual bird’s eye view feature map 50 from the ego vehicle 24 (FIG. 2) by comparing each feature vector 54 located within the first individual bird’s eye view feature map 50 with a predefined number n of equivalent individual feature vectors 54 located within each of the plurality of corresponding repaired feature maps 80 of the plurality of vehicles 24. It is to be appreciated that the predefined number n may be any value that is equal to or greater than two. The exact value of the predefined number n is based on the number of vehicles located within a radius of a predetermined distance (e.g., 80 meters). In the example as shown in FIG. 5, the predefined number n is 4.

The DSCA submodule 82 may first identify the specific position of the equivalent individual feature vectors 54 located within the plurality of corresponding repaired feature maps 80 for each feature vector 54 located within the first (ego vehicle’s) individual bird’s eye view feature map 50 based on a training process. The specific position of the equivalent individual feature vectors 54 may indicate a specific row and a specific column within a corresponding repaired feature map 80.

The training process begins by the DSCA submodule 82 selecting an n number of feature vectors 54 within a corresponding repaired featured map 80 at random and performing object detection upon the corresponding repaired feature map 80 to draw bounding boxes around objects located within the environment 26, where the objects located within the environment 26 may be, for example, the vehicles 24. The DSCA submodule 82 may then compare the bounding boxes of the corresponding repaired featured map 80 with bounding boxes that are determined based on corresponding ground truth data to calculate a loss function. Specifically, the loss function determines the distance between the bounding boxes of the corresponding feature map 80 with the bounding boxes based on the ground truth data. The DSCA submodule 82 may then execute one or more deep learning algorithms to identify the specific position of the equivalent individual feature vectors 54 located within the plurality of corresponding repaired feature maps 80 based on the loss function, where the equivalent feature vectors 54 include lowest loss are selected.

After the training process is complete, the DSCA submodule 82 may compare each feature vector 54 located within the first individual bird’s eye view feature map 50 with a predefined number n of equivalent individual feature vectors 54 located within each of the plurality of corresponding repaired feature maps 80 of the plurality of vehicles to determine an attention weight. The attention weight represents a similarity between a particular feature vector 54 located within the first individual bird’s eye view feature map 50 and an equivalent individual feature vector 54 located a corresponding repaired feature map 80. The DSCA submodule 82 may then calculate a unique cross attention map 86 corresponding to each of the predefined number n of equivalent individual feature vectors 54 located within the plurality of corresponding repaired feature maps 80, where each individual feature vector 54 of each unique cross attention map 86 represents a unique attention weight. In the example as shown in FIG. 5, the predefined number n is four, and therefore there are four unique cross attention maps 86A, 86B, 86C, 86D.

The DSCA submodule 82 may then determine the initial cross attention map 90 by transmitting each of the unique cross attention maps 86 to a max fusion block 88. The max fusion block 88 may then compare the attention weights corresponding to each feature vector 54 across each of the unique cross attention maps 86 corresponding to each specific position within the unique cross attention maps 86 to determine a maximum attention weight, and then assigns the attention weight of the feature vector 54 having the maximum attention weight to the feature vector 54 within the initial cross attention map 90 having the same specific position. For example, for the feature vector 54 having the specific position (1, 1), the max fusion block 88 may compare the attention weights for each feature vector 54 having the specific position (1, 1) across each of the unique cross attention maps 86A, 86B, 86C, 86D, and then assigns the attention weight of the feature vector 54 having the maximum attention weight to the feature vector 54 having the specific position of (1, 1) within the initial cross attention map 90.

Referring to FIGS. 3 and 7, the historical temporal alignment submodule 84 of the spatial-temporal fusion module 62 shall now be described. The historical temporal alignment submodule 84 of the spatial-temporal fusion module 62 receives the first individual bird’s eye view feature map 50 from the ego vehicle 24 (FIG. 2) at the current timestep (t), the second individual bird’s eye view feature map 50 from the ego vehicle 24 at a previous timestep (t – 1), a first ego vehicle pose 96 at the current timestamp (t), and a second ego vehicle pose 98 at the previous timestamp (t – 1). As explained below, the historical temporal alignment submodule 84 calculates the temporal attention map 92 by first transforming the second individual bird’s eye view feature map 50 from the ego vehicle 24 from the previous timestep (t – 1) to the current timestamp (t) based on a pose difference 100 between the first ego vehicle pose 96 and the second ego vehicle pose 98 to create a temporally aligned bird’s eye view feature map 102, and then performing deformable attention upon the temporally aligned bird’s eye view feature map 102 and the first individual bird’s eye view feature map 50. The temporal attention map 92 may address temporal misalignments within the first individual bird’s eye view feature map 50 from the ego vehicle 24 that are created by synchronization errors based on historical data regarding the pose of the ego vehicle 24.

Referring specifically to FIG. 7, the historical temporal alignment submodule 84 of the spatial-temporal fusion module 62 first determines the pose difference 100 between the first ego vehicle pose 96 and the second ego vehicle pose 98. It is to be appreciated that the first ego vehicle pose 96 and the second ego vehicle pose 98 are determined by fusing measurements collected by the IMU 42 and the GPS 44 (shown in FIG. 2) together. Once the historical temporal alignment submodule 84 determines the pose difference 100, the historical temporal alignment submodule 84 may then transform the second individual bird’s eye view feature map 50 from the ego vehicle 24 from the previous timestep (t – 1) to the current timestamp (t) based on a pose difference 100 between the first ego vehicle pose 96 and the second ego vehicle pose 98 to create the temporally aligned bird’s eye view feature map 102.

Continuing to refer to FIG. 7, the historical temporal alignment submodule 84 includes a deformable attention block 104 that performs deformable attention upon the upon the temporally aligned bird’s eye view feature map 102 and the first individual bird’s eye view feature map 50 to create the temporal attention map 92. The temporal attention map 92 includes a grid configuration 105 that defines a plurality of feature vectors 106, where each feature vector 106 signifies an attention weight. The attention weight represents a similarity between a particular feature vector 108 located within the temporally aligned bird’s eye view feature map 102 and an equivalent individual feature vector 54 located in the first individual bird’s eye view feature map 50.

As seen in FIG. 7, the historical temporal alignment submodule 84 includes a max fusion block 110. The max fusion block 110 receives the temporal attention map 92 and the initial cross attention map 90 as determined by the DSCA submodule 82 (FIG. 6) and compares the attention weights corresponding to each feature vector 54 within the initial cross attention map 90 with a corresponding feature vector 106 located in the same specific position within the temporal attention map 92 to determine a maximum attention weight. The max fusion block 110 then assigns the attention weight of the feature vector 54, 106 having the maximum attention weight to the feature vector 54 within the fused bird’s eye view attention map 94 having the same specific position.

Turning back to FIG. 3, the post-processing block 64 determines the bird’s eye view cooperative perception map 12 based on the fused bird’s eye view attention map 94. It is to be appreciated that the fused bird’s eye view attention map 94 is expressed as a matrix of floating-point numbers having a height H, width W, and channel C that is expressed as (H, W, C). The post-processing block 64 may include one or more post-processing modules such as, but not limited to, include a multi-scale window attention module (MSWin), a layer normalization module for normalizing the matrix of the fused bird’s eye view attention map 94, and a feedforward layer of a neural network.

Referring generally to the figures, the disclosed collaborative perception system provides various technical effects and benefits. Specifically, the bird’s eye view cooperative perception map overcomes the real-world challenges faced when attempting to share perception data collected from multiple vehicles such as spatial misalignments cause by localization errors, temporal misalignments created by synchronization errors, and data loss caused by unreliable or lossy wireless networks. In particular, it is to be appreciated that the approach to determine the bird’s eye view cooperative perception map addresses all three challenges (i.e., spatial misalignments, temporal misalignments, and data loss), unlike some approaches that are currently available.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A collaborative perception system for creating a bird’s eye view cooperative perception map based on bird’s eye view perception data collected by a plurality of vehicles, the collaborative perception system comprising:
one or more central computers in wireless communication with one or more controllers of each of the plurality of vehicles located in an environment, the one or more central computers executing instructions to:
receive an individual bird’s eye view feature map from each of the plurality of vehicles;
perform lost feature reconstruction to reconstruct one or more lost feature indices within the individual bird’s eye view feature map for each of the plurality of vehicles to create a plurality of corresponding repaired feature maps for each of the plurality of vehicles;
address spatial misalignments within a first individual bird’s eye view feature map from an ego vehicle based on the plurality of corresponding repaired feature maps for each the plurality of vehicles to create an initial cross attention map, wherein the first individual bird’s eye view feature map from the ego vehicle is based on a current timestep;
calculate a temporal attention map by transforming a second individual bird’s eye view feature map that is based on a previous timestep from the ego vehicle from the previous timestep to a current timestamp based on a difference between a first ego vehicle pose and a second ego vehicle pose to create a temporally aligned bird’s eye view feature map, and then performing deformable attention upon the temporally aligned bird’s eye view feature map and the first individual bird’s eye view feature map;
fuse the temporal attention map and the initial cross attention map together to create a fused bird’s eye view attention map; and
create the bird’s eye view cooperative perception map based on the fused bird’s eye view attention map.

2. The collaborative perception system of claim 1, wherein the one or more central computers include a masked autoencoder network having an encoder and a decoder.

3. The collaborative perception system of claim 2, wherein the one or more central computers execute instructions to:
patchify each of the individual bird’s eye view feature maps into a plurality of patches, wherein each patch is sized to include one or more feature vectors of the individual bird’s eye view feature map.

4. The collaborative perception system of claim 3, wherein the one or more central computers execute instructions to:
learn, by the encoder of the masked autoencoder network, characteristics of non-corrupted patches that are part of the individual bird’s eye view feature map that omit the one or more lost feature indices; and
recover, by the decoder of the masked autoencoder network, remaining patches of the individual bird’s eye view feature map that include the one or more lost feature indices based on the characteristics of the non-corrupted patches learned by the encoder to create the corresponding repaired feature map for each of the plurality of vehicles.

5. The collaborative perception system of claim 3, wherein the size of each patch is based on a level of detail required by the collaborative perception system and an amount computational power available by the one or more central computers.

6. The collaborative perception system of claim 1, wherein the one or more central computers determine the initial cross attention map by:
comparing each feature vector located within the first individual bird’s eye view feature map with a predefined number of equivalent individual feature vectors located within each of the plurality of corresponding repaired feature maps for each of the plurality of vehicles to determine an attention weight; and
calculating a unique cross attention map corresponding to each of the predefined number of equivalent individual feature vectors, wherein each individual feature vector of each unique cross attention map represents a unique attention weight.

7. The collaborative perception system of claim 6, wherein the attention weight represents a similarity between a particular feature vector located within the first individual bird’s eye view feature map and an equivalent individual feature vector located a corresponding repaired feature map.

8. The collaborative perception system of claim 6, wherein the one or more central computers determine the initial cross attention map by:
comparing the attention weights corresponding to each feature vector across each of the unique cross attention maps corresponding to each specific position within the unique cross attention maps to determine a maximum attention weight; and
assigning the attention weight of the feature vector having the maximum attention weight to the feature vector within the initial cross attention map having the same specific position.

9. The collaborative perception system of claim 1, wherein the one or more controllers of the plurality of vehicles are in wireless communication with one another based on a vehicle-to-everything (V2X) communication network.

10. The collaborative perception system of claim 6, wherein the one or more central computers fuse the temporal attention map and the initial cross attention map together to create the fused bird’s eye view attention map by:
comparing attention weights corresponding to each feature vector within the initial cross attention map with a corresponding feature vector located in the same specific position within the temporal attention map to determine a maximum attention weight; and
assigning the attention weight of the feature vector having the maximum attention weight to the feature vector within the fused bird’s eye view attention map having the same specific position.

11. A collaborative perception system for creating a bird’s eye view cooperative perception map based on bird’s eye view perception data collected by a plurality of vehicle, the collaborative perception system comprising:
an ego vehicle including one or more controllers in wireless communication with each of the plurality of vehicles located in an environment, the one or more controllers of the ego vehicle executing instructions to:
receive an individual bird’s eye view feature map from each of the plurality of vehicles;
perform lost feature reconstruction to reconstruct one or more lost feature indices within the individual bird’s eye view feature map for each of the plurality of vehicles to create a plurality of corresponding repaired feature maps for each of the plurality of vehicles;
address spatial misalignments within a first individual bird’s eye view feature map from an ego vehicle based on the plurality of corresponding repaired feature maps for each the plurality of vehicles to create an initial cross attention map, wherein the first individual bird’s eye view feature map from the ego vehicle is based on a current timestep, and wherein creating the initial cross attention map includes:
comparing each feature vector located within the first individual bird’s eye view feature map with a predefined number of equivalent individual feature vectors located within each of the plurality of corresponding repaired feature maps for each of the plurality of vehicles to determine an attention weight; and
calculating a unique cross attention map corresponding to each of the predefined number of equivalent individual feature vectors, wherein each individual feature vector of each unique cross attention map represents a unique attention weight;
calculate a temporal attention map by transforming a second individual bird’s eye view feature map that is based on a previous timestep from the ego vehicle from the previous timestep to a current timestamp based on a difference between a first ego vehicle pose and a second ego vehicle pose to create a temporally aligned bird’s eye view feature map, and then performing deformable attention upon the temporally aligned bird’s eye view feature map and the first individual bird’s eye view feature map;
fuse the temporal attention map and the initial cross attention map together to create a fused bird’s eye view attention map; and
create the bird’s eye view cooperative perception map based on the fused bird’s eye view attention map.

12. The collaborative perception system of claim 11, wherein the one or more controllers of the ego vehicle include a masked autoencoder network having an encoder and a decoder.

13. The collaborative perception system of claim 12, wherein the one or more controllers of the ego vehicle execute instructions to:
patchify each of the individual bird’s eye view feature maps into a plurality of patches, wherein each patch is sized to include one or more feature vectors of the individual bird’s eye view feature map.

14. The collaborative perception system of claim 13, wherein the one or more controllers of the ego vehicle execute instructions to:
learn, by the encoder of the masked autoencoder network, characteristics of non-corrupted patches that are part of the individual bird’s eye view feature map that omit the one or more lost feature indices; and
recover, by the decoder of the masked autoencoder network, remaining patches of the individual bird’s eye view feature map that include the one or more lost feature indices based on the characteristics of the non-corrupted patches learned by the encoder to create the corresponding repaired feature map for each of the plurality of vehicles.

15. The collaborative perception system of claim 13, wherein the size of each patch is based on a level of detail required by the collaborative perception system and an amount computational power available by the one or more controllers of the ego vehicle.

16. The collaborative perception system of claim 11, wherein the one or more controllers of the ego vehicle determine the initial cross attention map by:
comparing each feature vector located within the first individual bird’s eye view feature map with a predefined number of equivalent individual feature vectors located within each of the plurality of corresponding repaired feature maps for each of the plurality of vehicles to determine an attention weight; and
calculating a unique cross attention map corresponding to each of the predefined number of equivalent individual feature vectors, wherein each individual feature vector of each unique cross attention map represents a unique attention weight.

17. The collaborative perception system of claim 16, wherein the attention weight represents a similarity between a particular feature vector located within the first individual bird’s eye view feature map and an equivalent individual feature vector located a corresponding repaired feature map.

18. The collaborative perception system of claim 16, wherein the one or more controllers of the ego vehicle determine the initial cross attention map by:
comparing the attention weights corresponding to each feature vector across each of the unique cross attention maps corresponding to each specific position within the unique cross attention maps to determine a maximum attention weight; and
assigning the attention weight of the feature vector having the maximum attention weight to the feature vector within the initial cross attention map having the same specific position.

19. The collaborative perception system of claim 11, wherein the plurality of vehicles are in wireless communication with one another based on a vehicle-to-everything (V2X) communication network.

20. A collaborative perception system for creating a bird’s eye view cooperative perception map based on bird’s eye view perception data collected by a plurality of vehicles, the collaborative perception system comprising:
one or more central computers in wireless communication with one or more controllers of each of the plurality of vehicles located in an environment, the one or more central computers executing instructions to:
receive an individual bird’s eye view feature map from each of the plurality of vehicles;
perform lost feature reconstruction to reconstruct one or more lost feature indices within the individual bird’s eye view feature map for each of the plurality of vehicles to create a plurality of corresponding repaired feature maps for each of the plurality of vehicles;
address spatial misalignments within a first individual bird’s eye view feature map from an ego vehicle based on the plurality of corresponding repaired feature maps for each the plurality of vehicles to create an initial cross attention map, wherein the first individual bird’s eye view feature map from the ego vehicle is based on a current timestep;
calculate a temporal attention map by transforming a second individual bird’s eye view feature map that is based on a previous timestep from the ego vehicle from the previous timestep to a current timestamp based on a difference between a first ego vehicle pose and a second ego vehicle pose to create a temporally aligned bird’s eye view feature map, and then performing deformable attention upon the temporally aligned bird’s eye view feature map and the first individual bird’s eye view feature map;
fuse the temporal attention map and the initial cross attention map together to create a fused bird’s eye view attention map; and
create the bird’s eye view cooperative perception map based on the fused bird’s eye view attention map.
